(19) United States
(12) Patent Application Publication
(10) Pub. No.: US 2019/0114139 A1
(43) Pub. Date: Apr. 18, 2019

(54) Configurable Processor with Backside Look-Up Table

(71) Applicant: Guobiao ZHANG, Corvallis, OR (US)

(72) Inventor: Guobiao ZHANG, Corvallis, OR (US)

(73) Assignee: HangZhou HaiCun Information Technology Co., Ltd., HangZhou (CN)

(21) Appl. No.: 16/203,602

(22) Filed: Nov. 28, 2018

Related U.S. Application Data
(63) Continuation-in-part of application No. 15/588,643, filed on May 6, 2017.

(30) Foreign Application Priority Data
May 7, 2016 (CN) 201610300576.9
May 5, 2017 (CN) 201710311013.4

(51) Int. Cl. G06F 7/498; G06F 7/544

(52) U.S. Cl. CPC G06F 7/4988; G06F 7/544

(57) ABSTRACT

A configurable processor comprises a processor substrate with a front side and a backside. A programmable memory array is disposed on the backside for storing a look-up table (LUT) for a mathematical function, while an arithmetic logic circuit (ALC) is disposed on the front side for performing at least an arithmetic operation on selected data from the LUT, wherein said mathematical function includes more operation than the arithmetic operations performable by the ALC. Complex mathematical functions can be implemented and configured.

### CROSS-REFERENCE TO RELATED APPLICATIONS

This application is a continuation-in-part of U.S. patent application Ser. No. 15/588,643, filed May 6, 2017, which claims priority from Chinese Patent Application 201610300576.9, filed May 7, 2016; Chinese Patent Application 201710311013.4, filed May 5, 2017, in the State Intellectual Property Office of the People's Republic of China (CN), the disclosure of which are incorporated herein by references in their entireties.

### BACKGROUND

### 1. Technical Field of the Invention

The present invention relates to the field of integrated circuit, and more particularly to processors.

### 2. Prior Art

Conventional processors use logic-based computation (LBC), which carries out computation primarily with logic circuits (e.g. XOR circuit). Logic circuits are suitable for arithmetic functions, whose operations consist of basic arithmetic operations only, i.e. addition, subtraction and multiplication. However, logic circuits are not suitable for non-arithmetic functions, whose operations are more than the above arithmetic operations performable by the conventional logic circuits. Exemplary non-arithmetic functions include transcendental functions and special functions. Non-arithmetic functions are computationally hard and their hardware implementation has been a major challenge.

A complex function is a non-arithmetic function with multiple independent variables (independent variable is also known as input variable or argument). It can be expressed as a combination of basic functions. A basic function is a non-arithmetic function with a single independent variable. Exemplary basic functions include basic transcendental functions, such as exponential function (exp), logarithmic function (log), trigonometric functions (sin, cos, tan, a tan) and others.

For the conventional processors, all complex functions and most basic functions are implemented by software; only a small number of basic functions (e.g. basic algebraic functions and basic transcendental functions) are implemented by hardware, which are referred to as built-in functions. These built-in functions are realized by a combination of arithmetic operations and look-up tables (LUT). For example, U.S. Pat. No. 5,954,787 issued to Eun on Sep. 21, 1999 taught a method for generating sine/cosine functions using look-up tables; U.S. Pat. No. 9,207,910 issued to Azadet et al. on Dec. 8, 2015 taught a method for calculating a power function using LUTs.

Realization of built-in functions is further illustrated in FIG. 1A. A conventional processor 00X generally comprises a logic circuit 100X and a memory circuit 200X. The logic circuit 100X comprises an arithmetic logic unit (ALU) for performing arithmetic operations, whereas the memory circuit 200X stores an LUT for the built-in function. To obtain a desired precision, the built-in function is approximated to a polynomial of a sufficiently high order. The LUT 200X stores the coefficients of the polynomial; and the ALU 100X calculates the polynomial. Because the ALU 100X and the LUT 200X are formed side-by-side on a semiconductor substrate 00S, this type of horizontal integration is referred to as two-dimensional (2-D) integration.

The 2-D integration puts stringent requirements on the manufacturing process. As is well known in the art, the memory transistors in the LUT 200X are vastly different from the logic transistors in the ALC 100X. The memory transistors have stringent requirements on leakage current, while the logic transistors have stringent requirements on drive current. To form high-performance memory transistors and high-performance logic transistors at the same time is a challenge.

The 2-D integration also limits computational density and computational complexity. Computation has been developed towards higher computational density and greater computational complexity. The computational density, i.e. the computational power (e.g. the number of floating-point operations per second) per die area, is a figure of merit for parallel computation. The computational complexity, i.e. the total number of built-in functions supported by a processor, is a figure of merit for scientific computation. For the 2-D integration, inclusion of the LUT 200X increases the die size of the conventional processor OOX and lowers its computational density. This has an adverse effect on parallel computation. Moreover, because the ALU 100X, as the primary component of the conventional processor 00X, occupies a large die area, the LUT 200X is left with only a small die area and therefore, supports few built-in functions. FIG. 1B lists all built-in transcendental functions supported by an Intel Itanium (IA-64) processor (referring to Harrison et al. “The Computation of Transcendental Functions on the IA-64 Architecture”, Intel Technical journal, Q4 1999, hereinafter Harrison). The IA-64 processor supports a total of 7 built-in transcendental functions, each using a relatively small LUT (from 0 to 24 kb) in conjunction with a relatively high-order Taylor series (from 5 to 22).

The LBC-based processor OOX suffers one drawback. Because different logic circuits are used to realize different built-in functions, the processor OOX is fully customized. In other words, once its design is complete, the processor OOX can only realize a fixed set of pre-defined built-in functions. Apparently, configurable computation is more desirable, where a same hardware can realize different mathematical functions under the control of a set of configuration signals.

In the past, configurable logic, i.e. a same hardware realizes different logics under the control of a set of configuration signals, was realized by a configurable gate array, which is also known as field-programmable gate array (FPGA), complex programmable logic device (CPLD), or other names. U.S. Pat. No. 4,870,302 issued to Freeman on Sep. 26, 1989 (hereinafter Freeman) discloses a configurable gate array. It comprises an array of configurable logic elements and a hierarchy of configurable interconnects that allow the configurable logic elements to be wired together. In the prior-art configurable gate arrays, only logic functions are configurable, but mathematical functions are not configurable. A small number of mathematical functions (i.e. built-in functions) are realized in fixed computing elements, which are part of hard blocks. Namely, the circuits realizing these built-in functions are fixedly connected and are not subject to change by programming. Apparently, fixed computing elements would limit further applications of the configurable gate array. To overcome this difficulty, the present invention expands the original concept of the configurable gate array by making the fixed computing elements configurable.

### Objects and Advantages

It is a principle object of the present invention to realize configurable computation.

It is a further object of the present invention to realize field-configurable computation.

It is a further object of the present invention to realize re-configurable computation.

It is a further object of the present invention to realize configurable computation for complex functions.

It is a further object of the present invention to provide a configurable processor with a greater computational complexity.

It is a further object of the present invention to provide a configurable processor with a higher computational density.

It is a further object of the present invention to provide a configurable gate array with a greater computational flexibility.

In accordance with these and other objects of the present invention, the present invention discloses a configurable processor.

### SUMMARY OF THE INVENTION

The present invention discloses a configurable processor with a backside look-up table (BS-LUT), i.e. a BS-LUT configurable processor. The preferred BS-LUT configurable processor comprises a processor substrate and a plurality of configurable computing elements. Each configurable computing element comprises at least a programmable memory array on the backside of the processor substrate and at least an arithmetic logic circuit (ALC) on the front side of the processor substrate. The programmable memory array stores at least a portion of a look-up table (LUT) for a mathematical function, which includes numerical values related to said mathematical function (e.g. functional values and/or derivative values thereof), while the ALC performs arithmetic operations on selected data from the LUT. In general, the front side of the processor substrate comprises the ALCs of a plurality of configurable computing elements, while the backside of the processor substrate comprises the programmable memory arrays of another plurality of configurable computing elements. The programmable memory array on the front side and the ALC on the backside are communicatively coupled by a plurality of through-silicon vias. Located on the opposite side of the ALC, the LUT is referred to as backside LUT (BS-LUT). It should be apparent to those skilled in the art that the roles of the front side and backside can be reversed in other preferred embodiments, i.e. the programmable memory array can be formed on the front side of the processor substrate while the ALC can be formed on the backside of the processor substrate.

The preferred BS-LUT configurable processor uses memory-based computation (MBC), which realizes mathematical functions primarily with the LUT. Compared with the LUT used by the conventional processor, the BS-LUT used by the preferred BS-LUT configurable processor has a much larger capacity. Although arithmetic operations are still performed, the MBC only needs to calculate a polynomial to a much lower order because it uses a much larger BS-LUT as a starting point for computation. For the MBC, the fraction of computation done by the BS-LUT is more than the ALC.

Each usage cycle of the BS-LUT configurable processor comprises two stages: a configuration stage and a computation stage. In the configuration stage, the LUT for a desired mathematical function is written into the programmable memory array. In the computation stage, selected values of the mathematical function are read out from the programmable memory array. The BS-LUT configurable processor can realize field-configurable computation and re-configurable computation. For the field-configurable computation, a mathematical function is realized by writing its LUT into the programmable memory array in the field of use. For re-configurable computation, the programmable memory array is re-programmable and different mathematical functions can be realized by writing different LUTs for different mathematical functions thereto during different usage cycles. For example, during a first usage cycle, a first LUT for a first mathematical function is written into the re-programmable memory array; during a second usage cycle, a second LUT for a second mathematical function is written into the re-programmable memory array.

Because the ALC and the LUT are located on opposite sides of the processor substrate, this type of vertical integration is referred to as double-sided integration. The double-sided integration has a profound effect on the computational density and computational complexity. For the conventional 2-D integration, the footprint of a conventional processor 00X is roughly equal to the sum of those of the ALU 100X and the LUT 200X. On the other hand, because the double-sided integration moves the LUT from aside to the backside, the BS-LUT processor becomes smaller and computationally more powerful. In addition, the total LUT capacity of the conventional processor OOX is less than 100 Kb, whereas the total BS-LUT capacity for the BS-LUT processor could reach 100 Gb. Consequently, a single BS-LUT processor could support as many as 10,000 built-in functions (including various types of complex functions), far more than the conventional processor 00X. Furthermore, because the ALC and the LUT are on different sides of the processor substrate, the logic transistors in the ALC and the memory transistors in the LUT are formed in separate processing steps, which can be individually optimized.

To further improve configurability, the present invention further discloses a preferred BS-LUT configurable computing array for implementing complex functions. It is a special type of the BS-LUT configurable processor and comprises an array of configurable computing elements, an array of configurable logic elements and a plurality of configurable interconnects. Each configurable computing element comprises at least a programmable memory array for storing the LUT for a mathematical function and at least an ALC for performing arithmetic operations on selected data from the LUT. The configurable logic elements and configurable interconnects in the BS-LUT configurable computing array are similar to those in the conventional configurable gate array. During computation, a complex function is first decomposed into a combination of basic functions. Each basic function is then realized by an associated configurable computing element. Finally, the complex function is realized by programming the corresponding configurable logic elements and configurable interconnects.

Accordingly, the present invention discloses a configurable processor comprising a semiconductor substrate including a first side and a second side opposite to said first side and a plurality of configurable computing elements on said semiconductor substrate, each of said configurable computing elements comprising: at least a programmable memory array on said first side for storing at least a portion of a look-up table (LUT) for a mathematical function; at least an arithmetic logic circuit (ALC) on said second side for performing at least an arithmetic operation on selected data from said LUT; and means for communicatively coupling said programmable memory array and said ALC; wherein said mathematical function includes more operations than arithmetic operations performable by said ALC.

The present invention further discloses a configurable processor for implementing a mathematical function, comprising: a semiconductor substrate comprising a first side and a second side opposite to said first side; at least first and second programmable memory arrays on said first side, wherein said first programmable memory array stores at least a first portion of a first look-up table (LUT) for a first mathematical function; and, said second programmable memory array stores at least a second portion of a second LUT for a second mathematical function; at least an arithmetic logic circuit (ALC) on said second side for performing at least an arithmetic operation on selected data from said first or second LUT; and means for communicatively coupling said first or second programmable memory array with said ALC; wherein said mathematical function is a combination of at least said first and second mathematical functions; and, each of said first and second mathematical functions includes more operations than arithmetic operations performable by said ALC.

The present invention further discloses a configurable computing array for implementing a mathematical function, comprising: a semiconductor substrate comprising a first side and a second side opposite to said first side; at least an array of configurable computing elements comprising at least a first programmable memory array, a second programmable memory array and an arithmetic logic circuit (ALC), wherein said first programmable memory array stores at least a first portion of a first look-up table (LUT) for a first mathematical function; said second programmable memory array stores at least a second portion of a second LUT for a second mathematical function; and, said ALC performs at least an arithmetic operation on selected data from said first or second LUT; at least an array of configurable logic elements including a configurable logic element for selectively realizing a logic function in a logic library, wherein said first and second programmable memory arrays are located on said first side; and, either said configurable logic element or said ALC is located on said second side; means for communicatively coupling said configurable computing elements and said configurable logic elements; whereby said configurable computing array realizes said mathematical function by programming said configurable computing elements and said configurable logic elements, wherein said mathematical function is a combination of at least said first and second mathematical functions; wherein each of said first and second mathematical functions includes more operations than arithmetic operations included in said logic library; and, each of said first and second mathematical functions includes more operations than arithmetic operations performable by said ALC.

### BRIEF DESCRIPTION OF THE DRAWINGS

FIG. 1A is a schematic view of a conventional processor (prior art); FIG. 1B lists all transcendental functions supported by an Intel Itanium (IA-64) processor (prior art);

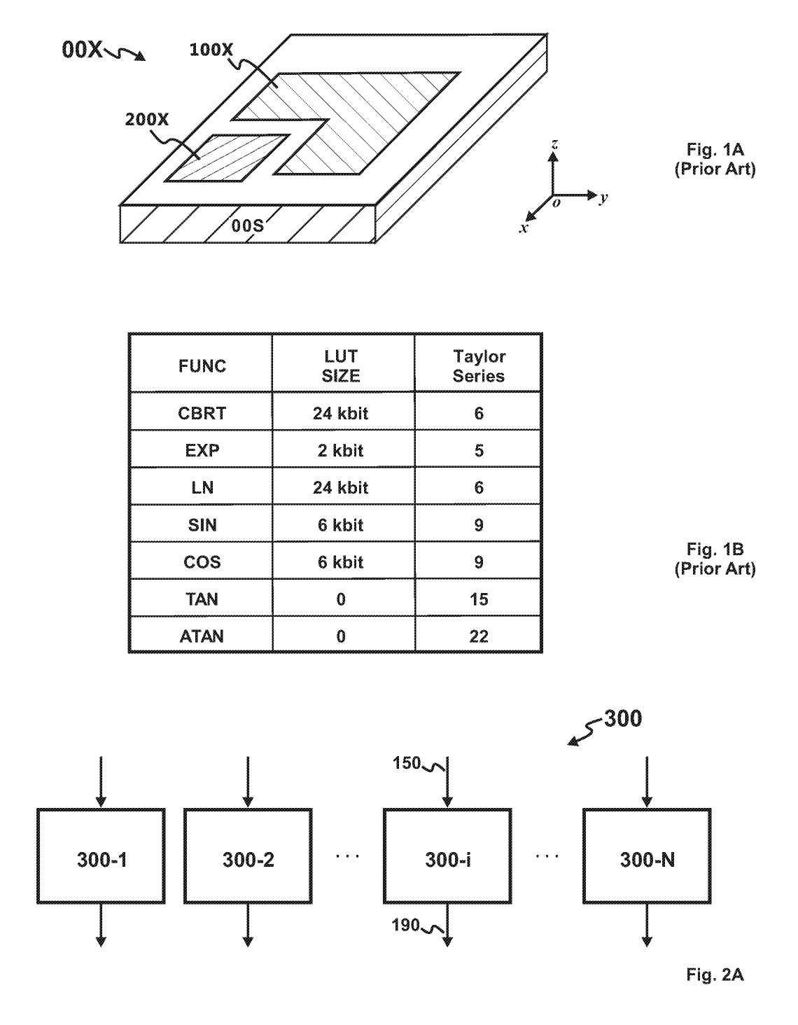

FIG. 2A is a block diagram of a preferred BS-LUT configurable processor; FIG. 2B is a block diagram of a preferred configurable computing element; FIG. 2C is a perspective view of the front side of the processor substrate; FIG. 2D is a perspective view of the backside of the processor substrate;

FIG. 3A is a cross-sectional view of the preferred BS-LUT configurable processor; FIG. 3B is a circuit layout view of its front side; FIG. 3C is a circuit layout view of its backside;

FIG. 4A is a circuit block diagram of a preferred configurable computing element showing more details; FIG. 4B is a circuit block diagram of the preferred configurable computing element realizing a single-precision function; FIG. 4C lists preferred LUT sizes and Taylor series required to realize mathematical functions with different precisions;

FIG. 5 is a block diagram of a first preferred BS-LUT configurable computing array;

FIG. 6 shows an instantiation of the first preferred BS-LUT configurable computing array for implementing a complex function, i.e. e=a·sin(b)+c·cos(d);

FIG. 7 is a block diagram of a second preferred BS-LUT configurable computing array;

FIGS. 8A-8B show two instantiations of the second preferred BS-LUT configurable computing array.

It should be noted that all the drawings are schematic and not drawn to scale. Relative dimensions and proportions of parts of the device structures in the figures have been shown exaggerated or reduced in size for the sake of clarity and convenience in the drawings. The same reference symbols are generally used to refer to corresponding or similar features in the different embodiments.

Throughout this specification, the phrase “mathematical functions” refer to non-arithmetic functions only; the phrase “memory” is used in its broadest sense to mean any semiconductor-based holding place for information, either permanent or temporary; the phrase “permanent” is used in its broadest sense to mean any long-term storage; the phrase “communicatively coupled” is used in its broadest sense to mean any coupling whereby information may be passed from one element to another element; the term “LUT” (or, “BS-LUT”) could refer to the logic look-up table (LUT) stored in the programmable memory array(s), or the physical LUT circuit in the form of the programmable memory array(s), depending on the context; the symbol “/” means a relationship of “and” or “or”.

### DETAILED DESCRIPTION OF THE PREFERRED EMBODIMENTS

Those of ordinary skills in the art will realize that the following description of the present invention is illustrative only and is not intended to be in any way limiting. Other embodiments of the invention will readily suggest themselves to such skilled persons from an examination of the within disclosure.

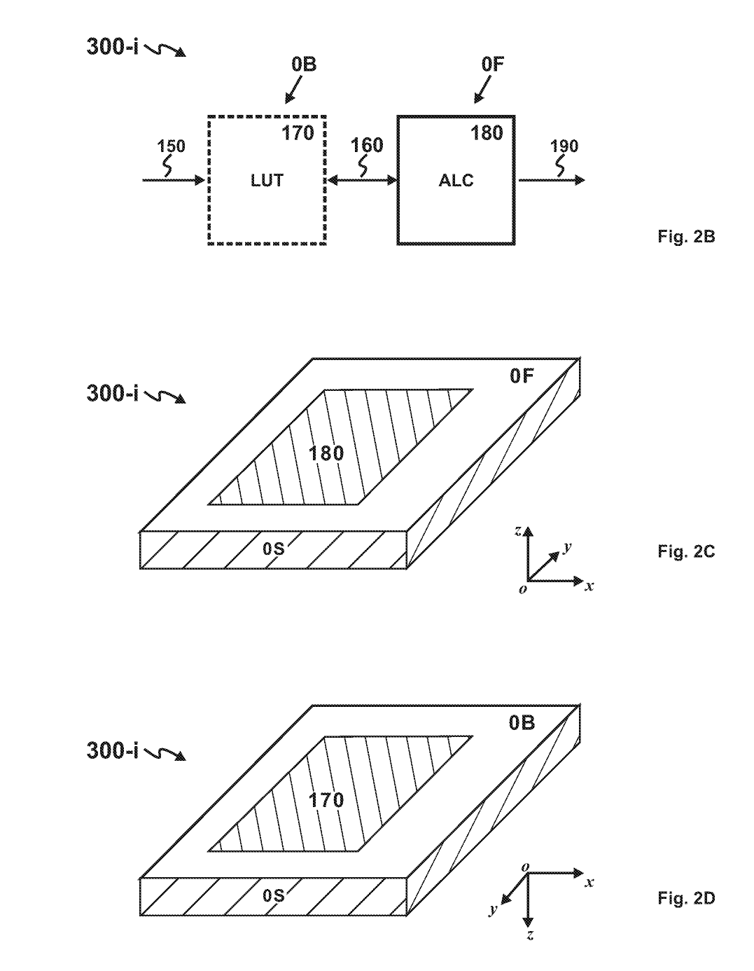

Referring now to FIG. 2A-2C, a preferred BS-LUT configurable processor 300 is disclosed. It comprises an array of configurable computing elements 300-1, 300-2 . . . 300-i . . . 300-N (FIG. 2A). Each configurable computing element 300-i could realize a same mathematical function or different mathematical functions. It has at least one input 150 and at least one output 190.

The configurable computing element 300-i comprises at least a programmable memory array 170 and an arithmetic logic circuit (ALC) 180, which are communicatively coupled by connections 160 (FIG. 2B). The programmable memory array 170 stores at least a portion of the LUT for a mathematical function. It may be a RAM array or a ROM array. The RAM could be SRAM or DRAM, while the ROM could be OTP, EPROM, EEPROM, flash memory (e.g. planar NOR memory, planar NAND memory, or 3D-NAND memory), or 3D-XPoint memory. The LUT includes numerical values related to said mathematical function. Examples of the numerical values include the functional values or the derivative values of said mathematical function. The ALC 180 performs at least an arithmetic operation on selected data from the LUT. It may comprise an adder, a multiplier, and/or a multiply-accumulator (MAC). The ALC 180 may operate on integer, fixed-point numbers, or floating-point numbers. The mathematical function implemented by the programmable memory array 170 is a non-arithmetic function, which includes more operations than the arithmetic operations performable by the ALC 180. As disclosed before, typical arithmetical operations performable by the ALC 180 consist of addition, subtraction and multiplication.

Each usage cycle of the BS-LUT configurable processor 300 comprises two stages: a configuration stage and a computation stage. In the configuration stage, the LUT for a desired mathematical function is written into the programmable memory array 170. In the computation stage, selected values of the mathematical function are read out from the programmable memory array 170. The BS-LUT configurable processor 300 can be used to realize field-configurable computation and re-configurable computation. For the field-configurable computation, a mathematical function is realized by writing its LUT into the programmable memory array 170 in the field of use. For re-configurable computation, the programmable memory array 170 is re-programmable and different mathematical functions can be realized by writing different LUTs for different mathematical functions into the re-programmable memory array 170. For example, during a first usage cycle, a first LUT for a first mathematical function is written into the re-programmable memory array 170; during a second usage cycle, a second LUT for a second mathematical function is written into the re-programmable memory array 170.

In the preferred configurable computing element 300-i, the ALC 180 is formed on the front side 0F of the processor substrate OS, while the programmable memory array 170 is formed on the backside 0B of the processor substrate OS (FIG. 2C). In general, the front side 0F comprises the ALCs 180 of a plurality of configurable computing elements, while the backside 0B comprises the programmable memory arrays 170 of another plurality of configurable computing elements. On a different physical level (e.g. an opposite sides of) than the ALC 180, the programmable memory array 170 is represented by dotted line in all figures.

The BS-LUT configurable processor 300 uses memory-based computation (MBC), which realizes mathematical functions primarily with the LUT. Compared with the LUT 200X used by the conventional processor 00X, the BS-LUT 170 used by the BS-LUT configurable processor 300 has a much larger capacity. Although arithmetic operations are still performed, the MBC only needs to calculate a polynomial to a much lower order because it uses a much larger BS-LUT 170 as a starting point for computation. For the MBC, the fraction of computation done by the BS-LUT 170 is more than the ALC 180.

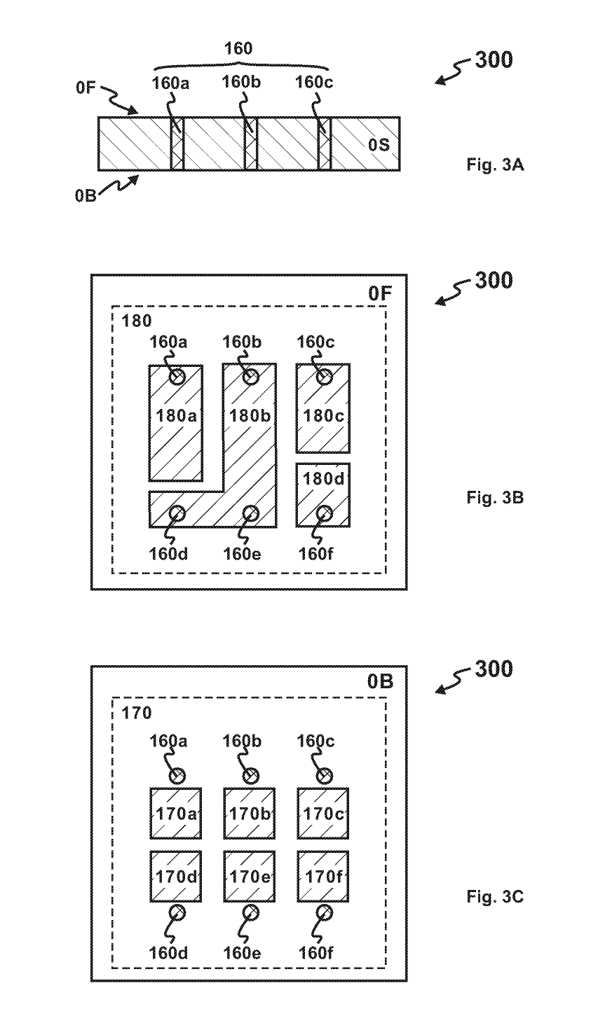

Referring now to FIGS. 3A-3C, more details of the preferred BS-LUT configurable processor 300 are shown. The BS-LUT processor 300 comprises a plurality of TSVs 160a-160c . . . through the processor substrate OS (FIG. 3A). The front side 0F of the processor substrate OS comprises at least an ALC 180 including the ALC components 180a-180d . . . (FIG. 3B). These ALC components 180a-180d are communicatively coupled with the TSVs 160a-160f . . . . On the other hand, the backside 0B of the processor substrate OS comprises the BS-LUT 170 including programmable memory arrays 170a-170f . . . (FIG. 3C). These programmable memory arrays 170a-170f are communicatively coupled with the TSVs 160a-160f . . . . The ALC 180 reads data from the BS-LUT 170 through the TSVs 160a-160f . . . , and performs arithmetic operations on these data. In the present invention, a memory array is a collection of all memory cells which share at least an address line.

Because the ALC 180 and the LUT 170 are formed on both sides 0F, 0B of the processor substrate OS, this type of vertical integration is referred to as double-sided integration. The double-sided integration has a profound effect on the computational density and computational complexity. For the conventional 2-D integration, the footprint of a conventional processor OOX is roughly equal to the sum of those of the ALU 100X and the LUT 200X. On the other hand, because the double-sided integration moves the LUT from aside to the backside 0B, the BS-LUT processor 300 becomes smaller and computationally more powerful. In addition, the total LUT capacity of the conventional processor OOX is less than 100 Kb, whereas the total BS-LUT capacity for the BS-LUT processor 300 could reach 100 Gb. Consequently, a single BS-LUT processor 300 could support as many as 10,000 built-in functions (including various types of complex functions), far more than the conventional processor 00X. Moreover, the double-sided integration can improve the communication throughput between the BS-LUT 170 and the ALC 180. Because they are physically close and coupled by a large number of TSV 160, the BS-LUT 170 and the ALC 180 have a larger communication throughput than that between the LUT 200X and the ALU 100X in the conventional processor 00X. Lastly, the double-sided integration benefits manufacturing process. Because the ALC 180 and the LUT 170 are on different sides 0F, 0B of the processor substrate OS, the logic transistors in the ALC 180 and the memory transistors in the LUT 170 may be formed in separate processing steps, which can be individually optimized.

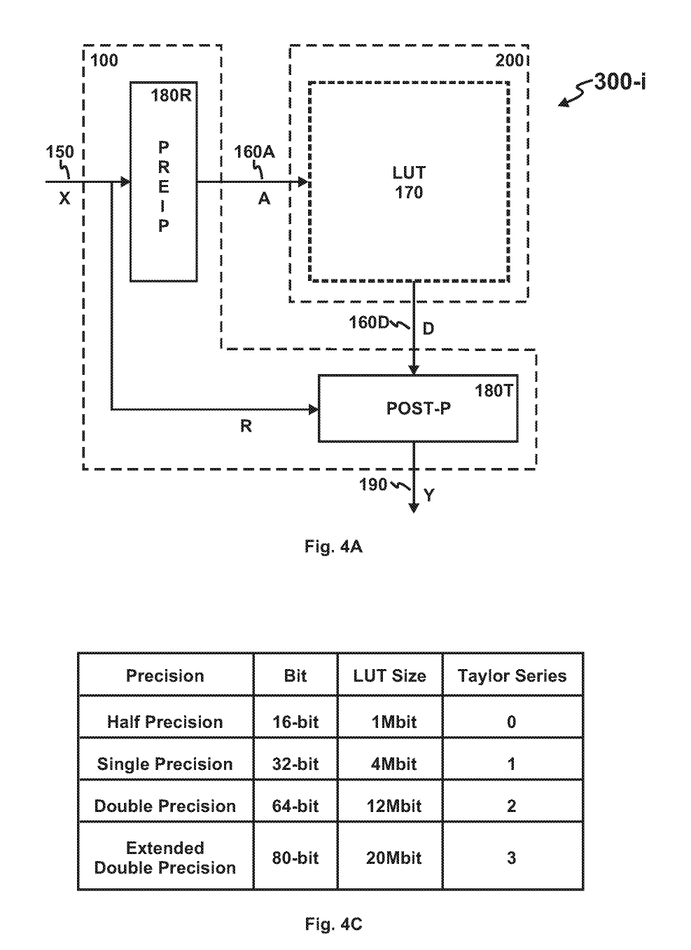

Referring now to FIGS. 4A-4C, more details on a preferred configurable computing element 300-i are disclosed. It comprises a pre-processing circuit 180R, a post-processing circuit 180T and at least a programmable memory array 170 for storing the LUT(s) for a mathematical function. The pre-processing circuit 180R converts the input variable (X) 150 into an address (A) 160A of the programmable memory array 170. After the data (D) 160D at the address (A) is read out from the programmable memory array 170, the post-processing circuit 180T converts it into the output value (Y) 190. A residue (R) of the input variable (X) is fed into the post-processing circuit 180T to improve the computational precision. In this example, the pre-processing circuit 180R and the post-processing circuit 180T are formed on the front side 0F. Alternatively, at least a portion of the pre-processing circuit 180R and the post-processing circuit 180T may be formed on the backside 0B.

FIG. 4B shows a preferred configurable computing element 400 realizing a single-precision mathematical function Y=f(X). The BS-LUT 170 includes two LUTs 170Q, 170R with 2 Mb capacity each (16-bit input and 32-bit output): the LUT 170Q includes the functional value of the mathematical function, i.e. D1=f(A), while the LUT 170R includes the first-order derivative value of the mathematical function, i.e. D2=f′(A). The ALC 180 comprises a pre-processing circuit 180R (mainly comprising an address buffer) and a post-processing circuit 180T (comprising an adder 180A and a multiplier 180M). The through-silicon vias 160 transfer data between the ALC 180 and the BS-LUT 170. During computation, a 32-bit input variable X (x₃₁ . . . x₀) is sent to the BS-LUT configurable processor 300 as an input 150. The pre-processing circuit 180R extracts the higher 16 bits (x₃₁ . . . x₁₆) and sends it as a 16-bit address input A to the BS-LUT 170. The pre-processing circuit 180R further extracts the lower 16 bits (x₁₅ . . . x₀) and sends it as a 16-bit input residue R to the post-processing circuit 180T. The post-processing circuit 180T performs a polynomial interpolation to generate a 32-bit output value Y 190. In this case, the polynomial interpolation is a first-order Taylor series: Y(X)=D1+D2*R=f(A)+f′(A)*R. Apparently, a higher-order polynomial interpolation (e.g. higher-order Taylor series) can be used to improve the computational precision.

When realizing a mathematical function, combining the LUT with polynomial interpolation can achieve a high precision without using an excessively large LUT. For example, if only LUT (without any polynomial interpolation) is used to realize a single-precision function (32-bit input and 32-bit output), it would have a capacity of 2³²*32=128 Gb. By including polynomial interpolation, significantly smaller LUTs can be used. In the above embodiment, a single-precision function can be realized using a total of 4 Mb LUT (2 Mb for the functional values, and 2 Mb for the first-order derivative values) in conjunction with a first-order Taylor series. This is significantly less than the LUT-only approach (4 Mb vs. 128 Gb).

FIG. 4C lists preferred LUT sizes and Taylor series required to realize mathematical functions with different precisions. It uses a range-reduction method taught by Harrison. For the half precision (16 bit), the required BS-LUT capacity is 2¹⁶16=1 Mb and no Taylor series is needed; for the single precision (32 bit), the required BS-LUT capacity is 2¹⁶*32*2=4 Mb and a first-order Taylor series is needed; for the double precision (64 bit), the required BS-LUT capacity is 2¹⁶*64*3=12 Mb and a second-order Taylor series is needed; for the extended double precision (80 bit), the required BS-LUT capacity is 2¹⁶*80*4=20 Mb and a third-order Taylor series is needed. To those skilled in the art, other combinations of LUT size and Taylor series can be used to optimize the LUT usage and arithmetic operations.

Besides transcendental functions, the preferred embodiment of FIGS. 4A-4B can be used to implement special functions. Special functions can be defined by means of power series, generating functions, infinite products, repeated differentiation, integral representation, differential difference, integral, and functional equations, trigonometric series, or other series in orthogonal functions. Important examples of special functions are gamma function, beta function, hyper-geometric functions, confluent hyper-geometric functions, Bessel functions, Legrendre functions, parabolic cylinder functions, integral sine, integral cosine, incomplete gamma function, incomplete beta function, probability integrals, various classes of orthogonal polynomials, elliptic functions, elliptic integrals, Lame functions, Mathieu functions, Riemann zeta function, automorphic functions, and others. The BS-LUT configurable processor will simplify the computation of special functions and promote their applications in scientific computation.

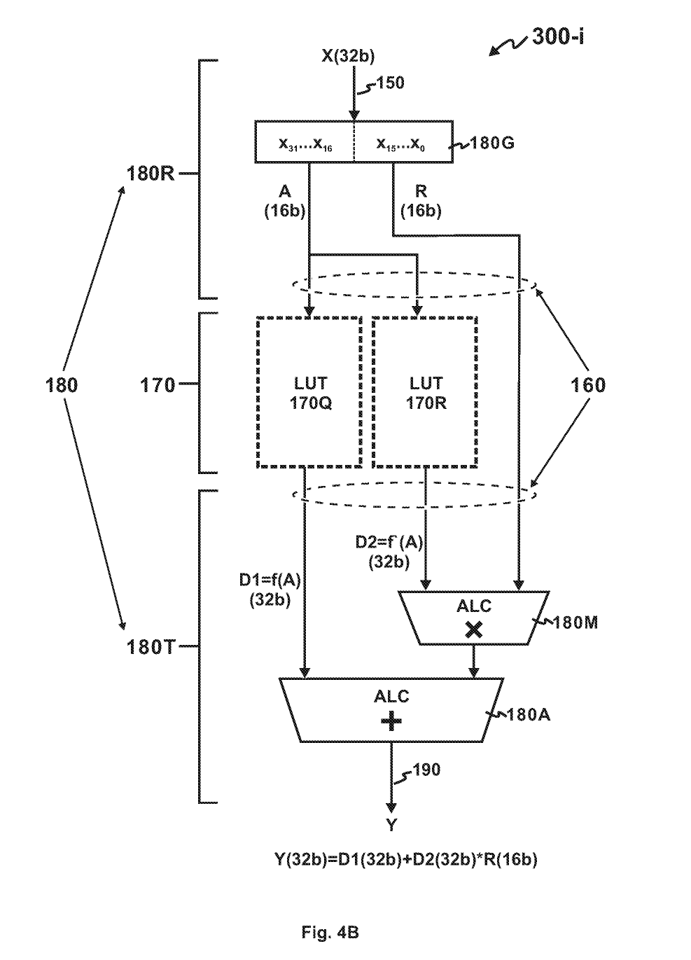

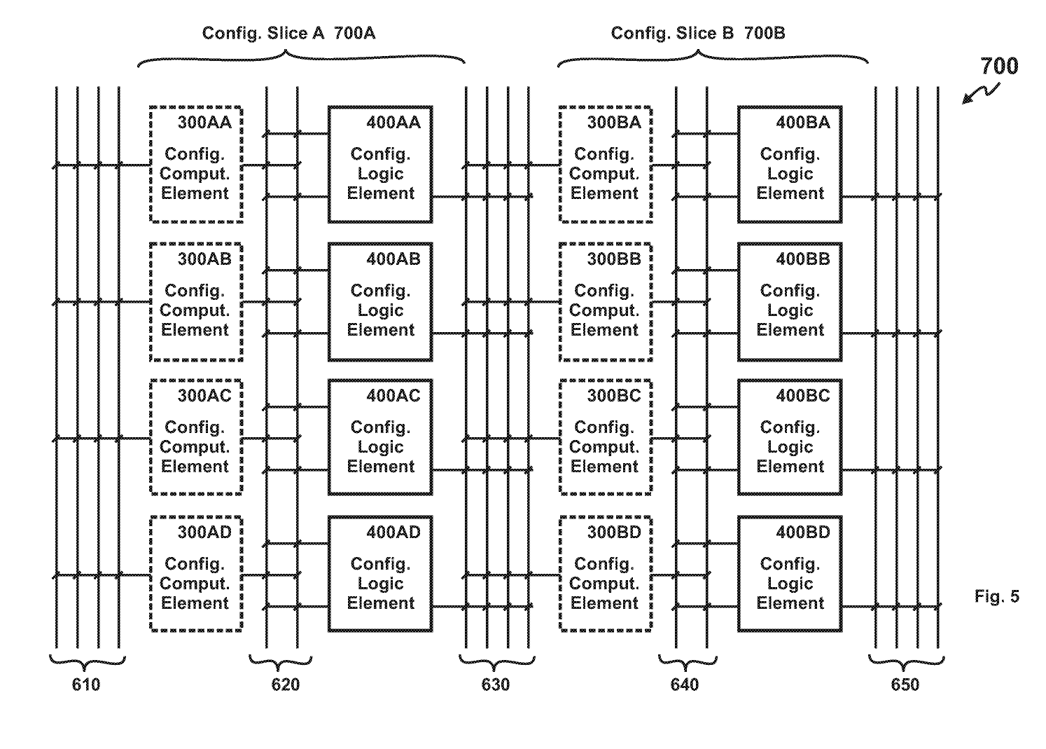

Referring now to FIGS. 5-6, a first preferred BS-LUT configurable computing array 700 is disclosed. It is a special type of the configurable processor 300 for implementing complex functions. The first preferred BS-LUT configurable computing array 700 comprises first and second configurable slices 700A, 700B. Each configurable slice (e.g. 700A) comprises a first array of configurable computing elements (e.g. 300AA-300AD) and a second array of configurable logic elements (e.g. 400AA-400AD). A configurable channel 620 is placed between the first array of configurable computing elements (e.g. 300AA-300AD) and the second array of configurable logic elements (e.g. 400AA-400AD). The configurable channels 610, 630, 650 are also placed between different configurable slices 700A, 700B. The configurable channels 610-650 comprise an array of configurable interconnects (represented by slashes at the cross-points in each configurable channel). For those skilled in the art, besides configurable channels, the sea-of-gates architecture may also be used.

The configurable computing elements 300AA-300BD are similar to those in the BS-LUT configurable processor 300 (FIG. 2B). Each configurable computing element 300-i comprises at least a programmable memory array 170 and an arithmetic logic circuit (ALC) 180. It can realize at least a basic function by loading the LUT for said basic function into the programmable memory array 170. The configurable logic elements 400AA-400BD and the configurable interconnects 610-650 are similar to those disclosed in Freeman (U.S. Pat. No. 4,870,302). Each configurable logic element can selectively realize any one of a plurality of logic operations in a logic library. A typical logic library includes a group of operations consisting of shift, logic NOT, logic AND, logic OR, logic NOR, logic NAND, logic XOR, addition “+”, and subtraction “−”. Each configurable interconnect can selectively couple or de-couple at least one interconnect line.

The first preferred BS-LUT configurable computing array 700 can realize a complex function by programming the configurable logic elements 400AA-400BD and the configurable computing elements 300AA-300BD. The complex function is a combination of basic functions, which can be implemented by selected configurable computing elements. The mathematical operations included in each basic function are not only more than the arithmetic operations included in the logic library of the configurable logic elements 400AA-400BD, but also more than the arithmetic operations performable by the ALC 180. In general, the arithmetic operations included in the logic library consist of addition and subtraction; and, the arithmetic operations performable by the ALC 180 consist of addition, subtraction and multiplication.

In one preferred BS-LUT configurable computing array 700, the programmable memory arrays 170 of the configurable computing elements 300AA-300BD are located on the backside 0B of the processor substrate OS, while the configurable logic elements 400AA-400BD are located on the front side 0F of the processor substrate OS. The ALCs 180 may be located on the front side 0F, together with the configurable logic elements 400AA-400BD. Alternatively, the ALCs 180 may be located on the backside 0B, together with the programmable memory arrays 170. The programmable memory arrays 170 and the configurable logic elements 400AA-400BB preferably at least partially overlap. It should be apparent to those skilled in the art that the programmable memory array 170 may be located on the front side 0F of the processor substrate OS, while the configurable logic elements 400AA-400BD may be located on the backside 0B of the processor substrate OS.

FIG. 6 discloses an instantiation of the first preferred BS-LUT configurable computing array 700 for implementing a complex function, i.e. e=a·sin(b)+c·cos(d). The configurable interconnects in the configurable channel 610-650 use the same convention as Freeman: the interconnect with a dot means that the interconnect is connected; the interconnect without dot means that the interconnect is not connected; a broken interconnect means that two broken sections are un-coupled. In this preferred instantiation, the configurable computing element 300AA is configured to realize the function log( ), whose result log(a) is sent to a first input of the configurable logic element 400AA. The configurable computing element 300AB is configured to realize the function log[sin( )], whose result log[sin(b)] is sent to a second input of the configurable logic element 400AA. The configurable logic element 400AA is configured to realize addition, whose result log(a)+log[sin(b)] is sent the configurable computing element 300BA. The configurable computing element 300BA is configured to realize the function exp( ), whose result exp{log(a)+log[sin(b)]}=a·sin(b) is sent to a first input of the configurable logic element 400BA. Similarly, through proper configurations, the results of the configurable computing elements 300AC, 300AD, the configurable logic elements 400AC, and the configurable computing element 300BC can be sent to a second input of the configurable logic element 400BA. The configurable logic element 400BA is configured to realize addition, whose result a·sin(b)+c·cos(d) is sent to the output e. Apparently, by changing its configuration, the BS-LUT configurable computing array 700 can realize other complex functions.

The first preferred BS-LUT configurable computing array 700 is particularly suitable for realizing complex functions. If only LUT is used to realize the above 4-variable function, i.e. e=a·sin(b)+c·cos(d), an enormous LUT is needed: 2¹⁶*2¹⁶*2¹⁶*2¹⁶*16=256 Eb even for half precision, which is impractical. Using the BS-LUT configurable gate array 700, only 8 Mb LUT (including 8 configurable computing elements, each with 1 Mb capacity) is needed to realize a 4-variable function. To those skilled in the art, the first preferred BS-LUT configurable computing array 700 can be used to realize other complex functions.

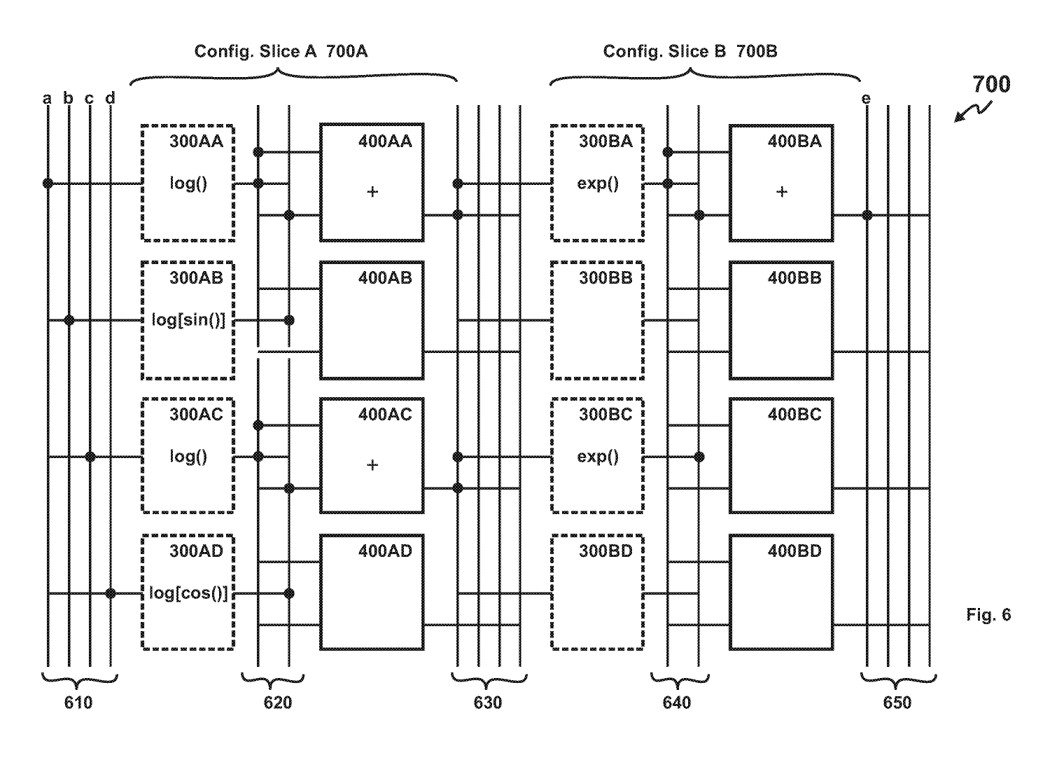

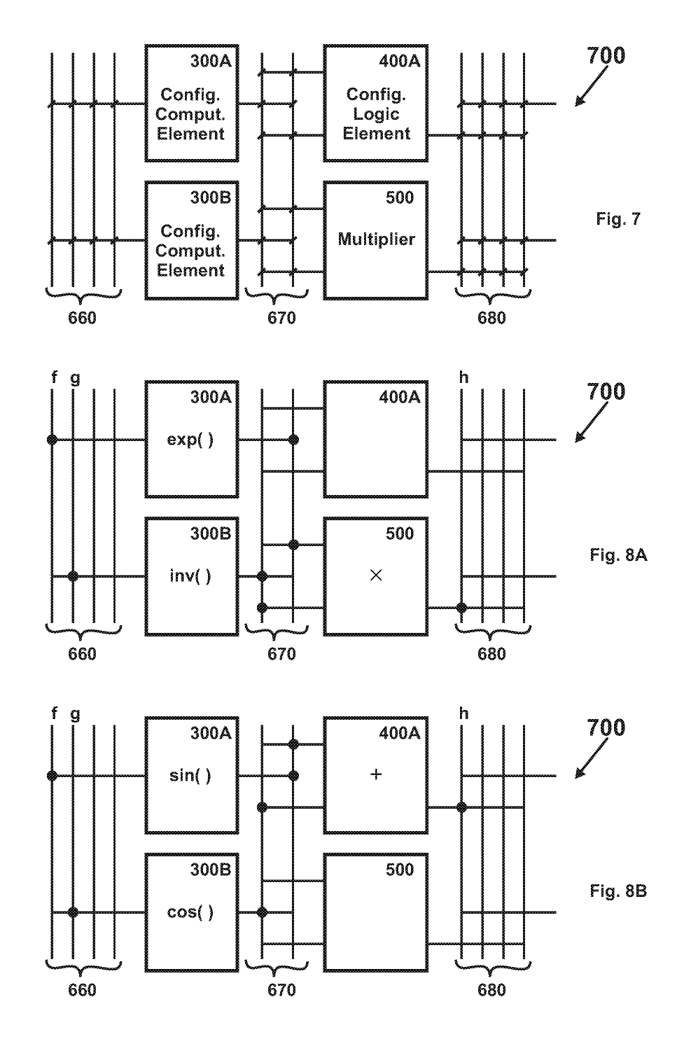

Referring now to FIGS. 7-8B, a second preferred BS-LUT configurable computing array 700 is shown. Besides configurable computing elements 300A, 300B and configurable logic element 400A, this preferred embodiment further comprises a multiplier 500. The configurable channels 660-680 comprise a plurality of configurable interconnects. With the addition of the multiplier 500, the second preferred BS-LUT configurable computing array 700 can realize more mathematical functions with more computational power.

FIGS. 8A-8B disclose two instantiations of the second preferred BS-LUT configurable computing array 700. In the instantiation of FIG. 8A, the configurable computing element 300A is configured to realize the function exp(f), while the configurable computing element 300B is configured to realize the function inv(g). The configurable channel 670 is configured in such a way that the outputs of 300A, 300B are fed into the multiplier 500. The final output is then h=exp(f)*inv(g). On the other hand, in the instantiation of FIG. 8B, the configurable computing element 300A is configured to realize the function sin(f), while the configurable computing element 300B is configured to realize the function cos(g). The configurable channel 670 is configured in such a way that the outputs of 300A, 300B are fed into the configurable logic element 400A, which is configured to realize arithmetic addition. The final output is then h=sin(f)+cos(g).

While illustrative embodiments have been shown and described, it would be apparent to those skilled in the art that many more modifications than that have been mentioned above are possible without departing from the inventive concepts set forth therein. For example, the BS-LUT configurable processor of the present invention could be a micro-controller, a controller, a central processing unit (CPU), a digital signal processor (DSP), a graphic processing unit (GPU), a network-security processor, an encryption/decryption processor, an encoding/decoding processor, a neural-network processor, or an artificial intelligence (AI) processor. These BS-LUT configurable processors can be found in consumer electronic devices (e.g. personal computers, video game machines, smart phones) as well as engineering and scientific workstations and server machines. The invention, therefore, is not to be limited except in the spirit of the appended claims.

What is claimed is:

1. A configurable processor comprising a semiconductor substrate including a first side and a second side opposite to said first side and a plurality of configurable computing elements on said semiconductor substrate, each of said configurable computing elements comprising:
at least a programmable memory array on said first side for storing at least a portion of a look-up table (LUT) for a mathematical function;
at least an arithmetic logic circuit (ALC) on said second side for performing at least an arithmetic operation on selected data from said LUT; and
means for communicatively coupling said programmable memory array and said ALC;
wherein said mathematical function includes more operations than arithmetic operations performable by said ALC.

2. The configurable processor according to claim 1, wherein said arithmetic operations performable by said ALC consist of addition, subtraction and multiplication.

3. The configurable processor according to claim 1, wherein said programmable memory array and said ALC at least partially overlap.

4. The configurable processor according to claim 1, wherein said programmable memory array is a re-programmable memory array, whereby said configurable processor can be re-configured to realize different mathematical functions.

5. The configurable processor according to claim 1, wherein said programmable memory array is a RAM array or ROM array.

6. A configurable processor for implementing a mathematical function, comprising:
a semiconductor substrate comprising a first side and a second side opposite to said first side;
at least first and second programmable memory arrays on said first side, wherein said first programmable memory array stores at least a first portion of a first look-up table (LUT) for a first mathematical function; and, said second programmable memory array stores at least a second portion of a second LUT for a second mathematical function;
at least an arithmetic logic circuit (ALC) on said second side for performing at least an arithmetic operation on selected data from said first or second LUT; and
means for communicatively coupling said first or second programmable memory array with said ALC;
wherein said mathematical function is a combination of at least said first and second mathematical functions; and, each of said first and second mathematical functions includes more operations than arithmetic operations performable by said ALC.

7. The configurable processor according to claim 6, wherein said arithmetic operations performable by said ALC consist of addition, subtraction and multiplication.

8. The configurable processor according to claim 6, wherein said programmable memory array and said ALC at least partially overlap.

9. The configurable processor according to claim 6, wherein said first and second programmable memory arrays are re-programmable memory arrays, whereby said configurable processor can be re-configured to realize different mathematical functions.

10. The configurable processor according to claim 6, wherein said first and second programmable memory arrays are RAM arrays or ROM arrays.

11. A configurable computing array for implementing a mathematical function, comprising:
a semiconductor substrate comprising a first side and a second side opposite to said first side;
at least an array of configurable computing elements comprising at least a first programmable memory array, a second programmable memory array and an arithmetic logic circuit (ALC), wherein said first programmable memory array stores at least a first portion of a first look-up table (LUT) for a first mathematical function; said second programmable memory array stores at least a second portion of a second LUT for a second mathematical function; and, said ALC performs at least an arithmetic operation on selected data from said first or second LUT;
at least an array of configurable logic elements including a configurable logic element for selectively realizing a logic function in a logic library, wherein said first and second programmable memory arrays are located on said first side; and, either said configurable logic element or said ALC is located on said second side;
means for communicatively coupling said configurable computing elements and said configurable logic elements;
whereby said configurable computing array realizes said mathematical function by programming said configurable computing elements and said configurable logic elements, wherein said mathematical function is a combination of at least said first and second mathematical functions;
wherein each of said first and second mathematical functions includes more operations than arithmetic operations included in said logic library; and, each of said first and second mathematical functions includes more operations than arithmetic operations performable by said ALC.

12. The configurable computing array according to claim 11, wherein said arithmetic operations included in said logic library consist of addition and subtraction.

13. The configurable computing array according to claim 11, wherein said arithmetic operations performable by said ALC consist of addition, subtraction and multiplication.

14. The configurable computing array according to claim 11, further comprising at least a plurality of configurable interconnects including a configurable interconnect, wherein said configurable interconnect selectively realizes an interconnect from an interconnect library.

15. The configurable computing array according to claim 11, wherein said programmable memory array is a re-programmable memory array, whereby said configurable computing array can be re-configured to realize different mathematical functions.

16. The configurable computing array according to claim 11, wherein said first or second programmable memory array at least partially overlaps said ALC or said configurable logic element.

17. The configurable computing array according to claim 11, wherein said first and second programmable memory arrays are RAM arrays or ROM arrays.

18. The configurable computing array according to claim 11, wherein said configurable logic element is located on said second side.

19. The configurable computing array according to claim 11, wherein said ALC is located on said second side.

20. The configurable computing array according to claim 11, wherein said configurable logic element and said ALC are located on said second side.
